(19) United States
(12) Patent Application Publication
(10) Pub. No.: US 2025/0328570 A1
(43) Pub. Date: Oct. 23, 2025

(54) CALL CENTER DATA MINING APPLICATIONS

(71) Applicant: DISH Wireless L.L.C., Englewood, CO (US)

(72) Inventors: Anastasiia Zhiboedova, San Francisco, CA (US); Mikhail Arbuzov, Santa Clara, CA (US); Dmitry Dimov, San Francisco, CA (US); Sisong Bei, Dublin, CA (US); Junji Wiener, Golden, CO (US)

(21) Appl. No.: 18/639,664

(22) Filed: Apr. 18, 2024

(51) Int. Cl. G06F 16/34; G06F 16/35; G06F 40/166; G06F 40/253

(52) U.S. Cl. CPC G06F 16/345; G06F 16/358; G06F 40/166; G06F 40/253

(57) ABSTRACT

A disclosed method may include (i) transforming an original corpus of support call transcriptions for support calls received at a telecommunication provider at least in part by prompting a large language model to summarize each support call transcript in the original corpus of support call transcripts for the support calls received at the telecommunication provider to output a summary corpus of large language model generated summaries of support call transcriptions, (ii) extracting from the summary corpus of large language model generated summaries of support call transcriptions a ranked ordering of client support topics for clusters within the summary corpus of large language model generated summaries of support call transcriptions, and (iii) resolving, by the telecommunication provider, the client support topics in an actual order that is determined at least in part based on the ranked ordering of client support topics for clusters within the summary corpus.

### BRIEF SUMMARY

This disclosure is generally directed to systems, methods, and computer-readable media relating to call center data mining applications, as discussed in more detail below. Organizations including telecommunication providers often field large volumes of customer support calls to customer support call centers and/or other traffic (e.g., emails) describing problems or complaints associated with these organizations and their products or services. In some scenarios with large organizations the volume of traffic can be so large that it is impractical or effectively impossible for the large organizations to run meaningful analytics on the traffic in a manner that provides real time feedback to the organizations. Ideally, such feedback would be real time in the sense that a month's worth of traffic can generate meaningful analytics and/or statistics or other feedback fast enough to be provided to the organization before the next month of traffic begins or fast enough to be completed within one month. A slower rate of processing, analyzing, labeling, categorizing, clustering, running statistics, and/or reporting such feedback would not be fast enough to keep pace with the generation of new traffic such that the overall analytics processing pipeline would quickly become overrun and the feedback cannot be provided in real time. Currently, in some related systems, the amount of volume for some organizations is so large that the traffic effectively becomes a black box where each customer benefits from the audio conversation with the agent at the call center, individually, and yet no meaningful statistics or analytics can be performed in real time on these conversations generating actionable business items and insights to be reported to the organization in real time.

In view of the above, it would be desirable or beneficial to develop techniques for rendering the overall processing time shorter so as to cross the threshold toward real time processing. Various techniques can be used or suggested for helping to achieve this goal and cross the threshold, including increases in computational speed and/or price performance. In various examples and embodiments, this disclosure focuses upon a technique that helps to cross the threshold toward real time processing by leveraging a key insight of using a large language model to summarize the transcript of the conversation between the agent and the customer. Accordingly, this disclosure describes inventive techniques for newly using such large language model summarization procedures in the context of high-volume call center support traffic for an organization at scale such that the threshold to real time processing and reporting can be achieved, as discussed in more detail below.

In one example, a method may include (i) transforming an original corpus of support call transcriptions for support calls received at a telecommunication provider at least in part by prompting a large language model in a series of models to summarize each support call transcript in the original corpus of support call transcripts for the support calls received at the telecommunication provider to output a summary corpus of large language model generated summaries of support call transcriptions, (ii) vectorizing, by a sentence embeddings model, the summary corpus of large language model generated summaries of support call transcriptions such that an original vector corpus is produced with a respective vector for each large language model generated summary in the summary corpus of large language model generated summaries, (iii) extracting, by referencing the original vector corpus, from the summary corpus of large language model generated summaries of support call transcriptions a ranked ordering of client support topics for clusters within the summary corpus of large language model generated summaries of support call transcriptions, (iv) resolving, by the telecommunication provider, the client support topics in an actual order that is determined at least in part based on the ranked ordering of client support topics for clusters within the summary corpus of large language model generated summaries of support call transcriptions, and (v) improving accuracy of at least one earlier model in the series of models based on feedback received from a later model in the series of models.

In some examples, the method includes generating the original corpus of support call transcriptions by transcribing the support calls received at the telecommunication provider.

In some examples, transcribing comprises at least one of removing personally identifiable information, updating punctuation, labelling with at least one sentiment label, or performing proofreading.

In some examples, the large language model has been fine-tuned on a domain relating to the support calls received at the telecommunication provider, the large language model is specific to the domain relating to the support calls received at the telecommunication provider, the large language model has been optimized for generating summaries, or prompting the large language model is performed using a prompt format for generating summaries that has been selected as superior from among multiple tested prompt formats for generating summaries.

In some examples, the method includes performing domain adaptation on the large language model.

In some examples, the method includes labeling the clusters with the client support topics by prompting, for each respective cluster, a same or different large language model to generate a respective label based on reading a sample of the large language model generated summaries of support call transcriptions within the respective cluster.

In some examples, the method includes training a helper large language model on a corpus of training data that is tailored to address a specific client support topic for a specific cluster from the ranked ordering of client support topics for clusters within the summary corpus of large language model generated summaries of support call transcriptions.

In some examples, extracting the ranked ordering of client support topics for clusters within the summary corpus of large language model generated summaries of support call transcriptions comprises quantifying a first cost for a first cluster in terms of call center load or effect on client lifetime value.

In some examples, extracting the ranked ordering of client support topics for clusters within the summary corpus of large language model generated summaries of support call transcriptions comprises quantifying a second cost for the first cluster of resolving the respective topic for the first cluster.

In some examples, extracting the ranked ordering of client support topics for clusters within the summary corpus of large language model generated summaries of support call transcriptions comprises quantifying a return on investment for the first cluster by increasing the return on investment in proportion to the first cost or reducing the return on investment in proportion to the second cost.

In some examples, extracting the ranked ordering of client support topics for clusters within the summary corpus of large language model generated summaries of support call transcriptions comprises ranking a first respective cluster higher based on a first return on investment for the first cluster being higher than a second return on investment for a second cluster in the clusters.

In some examples, the client support topics comprise at least two of: phone activations or transfers, troubleshooting electronic subscriber identity module activations, customers seeking account access, general confusion, or language barriers.

In some examples, the sentence embeddings model comprises all-MiniLM-L6-v2.

In some examples, the method further includes performing dimensionality reduction on the original vector corpus to generate a reduced vector corpus.

In some examples, performing dimensionality reduction is performed according to uniform manifold approximation and projection.

In some examples, the method further includes generating the clusters within the summary corpus of large language model generated summaries of support call transcriptions at least in part by extracting the clusters from the reduced vector corpus.

In some examples, performing dimensionality reduction is performed through a graphics processing unit or extracting the clusters from the reduced vector corpus is performed through the graphics processing unit.

In some examples, generating the clusters is performed according to hierarchical density-based spatial clustering of applications with noise.

In some examples, a system includes at least one physical computing processor of a computing device and a non-transitory computer-readable medium that has instructions stored thereon that, when executed by the at least one physical computing processor, cause the computing device to perform operations comprising (i) transforming an original corpus of support call transcriptions for support calls received at a telecommunication provider at least in part by prompting a large language model in a series of models to summarize each support call transcript in the original corpus of support call transcripts for the support calls received at the telecommunication provider to output a summary corpus of large language model generated summaries of support call transcriptions, (ii) vectorizing, by a sentence embeddings model, the summary corpus of large language model generated summaries of support call transcriptions such that an original vector corpus is produced with a respective vector for each large language model generated summary in the summary corpus of large language model generated summaries, (iii) extracting, by referencing the original vector corpus, from the summary corpus of large language model generated summaries of support call transcriptions a ranked ordering of client support topics for clusters within the summary corpus of large language model generated summaries of support call transcriptions, (iv) resolving, by the telecommunication provider, the client support topics in an actual order that is determined at least in part based on the ranked ordering of client support topics for clusters within the summary corpus of large language model generated summaries of support call transcriptions, and (v) improving accuracy of at least one earlier model in the series of models based on feedback received from a later model in the series of models.

In some examples, a non-transitory computer-readable medium has instructions stored thereon that, when executed by at least one physical computing processor, cause a computing device to perform operations comprising: (i) transforming an original corpus of support call transcriptions for support calls received at a telecommunication provider at least in part by prompting a large language model in a series of models to summarize each support call transcript in the original corpus of support call transcripts for the support calls received at the telecommunication provider to output a summary corpus of large language model generated summaries of support call transcriptions, (ii) vectorizing, by a sentence embeddings model, the summary corpus of large language model generated summaries of support call transcriptions such that an original vector corpus is produced with a respective vector for each large language model generated summary in the summary corpus of large language model generated summaries, (iii) extracting, by referencing the original vector corpus, from the summary corpus of large language model generated summaries of support call transcriptions a ranked ordering of client support topics for clusters within the summary corpus of large language model generated summaries of support call transcriptions, (iv) resolving, by the telecommunication provider, the client support topics in an actual order that is determined at least in part based on the ranked ordering of client support topics for clusters within the summary corpus of large language model generated summaries of support call transcriptions, and (v) improving accuracy of at least one earlier model in the series of models based on feedback received from a later model in the series of models.

### BRIEF DESCRIPTION OF THE DRAWINGS

For a better understanding of the present invention, reference will be made to the following Detailed Description, which is to be read in association with the accompanying drawings:

FIG. 1 shows a flow diagram for a method relating to call-center data mining applications.

FIG. 2 shows a diagram of a customer calling a customer support call center of a mobile network operator or a mobile virtual network operator.

FIG. 3 shows a figurative diagram of a transcript of a call between the customer and an agent at the customer support call center.

FIG. 4 shows a figurative diagram of a summarization of the transcript of the call between the customer and the agent at the customer support call center where the summarization was generated by a large language model.

FIG. 5 shows a diagram of at least five models used in sequence as part of call center data mining applications.

FIG. 6 shows a diagram of a vector representation corresponding to word embeddings for the summarization of the transcript as part of the call center data mining applications.

FIG. 7 shows a figurative diagram indicating how a clustering model can extract clusters from a multiplicity of topics or text strings.

FIG. 8 shows a diagram illustrating how a large context summarization model can summarize, label, or assign a topic to each cluster from the extracted clusters.

FIG. 9 shows a diagram illustrating how the large context summarization model can be leveraged to summarize clusters of topics corresponding to transcripts of calls between various customers and the customer support call center.

FIG. 10 shows a flow diagram for another method relating to call center data mining applications.

FIG. 11 shows a diagram of an example computing system that may facilitate the performance of one or more of the methods described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

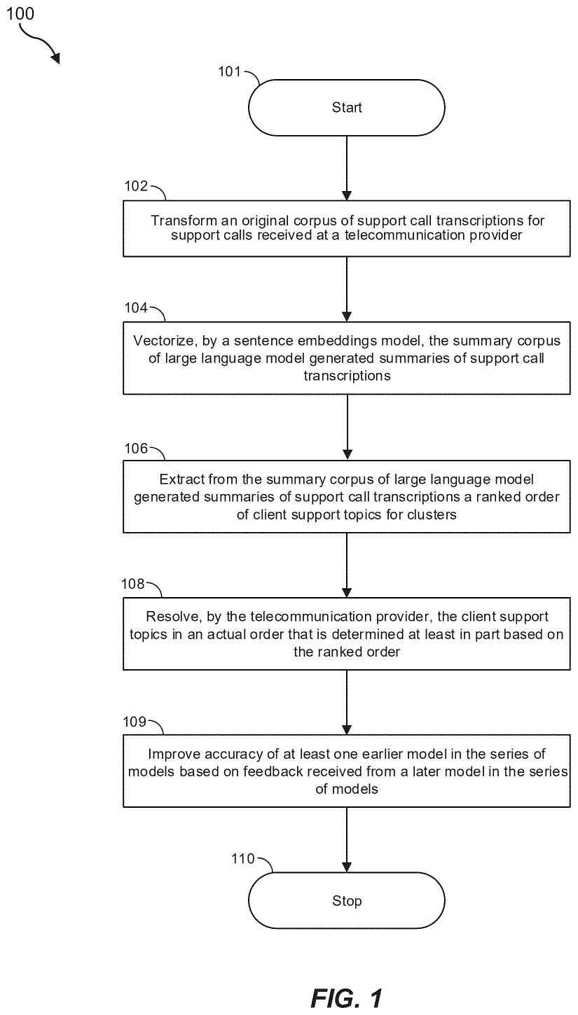

FIG. 1 shows a flow diagram for an example method 100 relating to pattern detection within a cellular telecommunication network core implemented within a cloud computing platform. At step 101, method 100 may start or begin. At step 102, method 100 may include transforming an original corpus of support call transcriptions for support calls received at a telecommunication provider at least in part by prompting a large language model in a series of models to summarize each support call transcript in the original corpus of support call transcripts for the support calls received at the telecommunication provider to output a summary corpus of large language model generated summaries of support call transcriptions. At step 104, method 100 may include vectorizing, by a sentence embeddings model, the summary corpus of large language model generated summaries of support call transcriptions such that an original vector corpus is produced with a respective vector for each large language model generated summary in the summary corpus of large language model generated summaries. At step 106, method 100 may include extracting, by referencing the original vector corpus, from the summary corpus of large language model generated summaries of support call transcriptions a ranked ordering of client support topics for clusters within the summary corpus of large language model generated summaries of support call transcriptions. At step 108, method 100 may include resolving, by the telecommunication provider, the client support topics in an actual order that is determined at least in part based on the ranked ordering of client support topics for clusters within the summary corpus of large language model generated summaries of support call transcriptions. At step 109, method 100 may include improving accuracy of at least one earlier model in the series of models based on feedback received from a later model in the series of models. At step 110, method 100 may stop or conclude.

As used herein, the term “original corpus of support call transcriptions” can refer to a set of support call transcriptions to be used as the input for one or more of the procedures described within this disclosure and prior to the summarizing action of step 102. As used herein, the term “summary corpus of large language model generated summaries of support culture transcriptions” can generally refer to a set, as output, based on the original corpus of summary call transcriptions, after the performance of the summarization act of step 102, thereby generating a respective summary for each support call transcription for each respective support call. As used herein, the term “telecommunication provider” can refer to mobile network operators, mobile virtual network operators, and/or content providers such as television providers and/or direct-broadcast satellite providers that provide content to clients or customers using telecommunication.

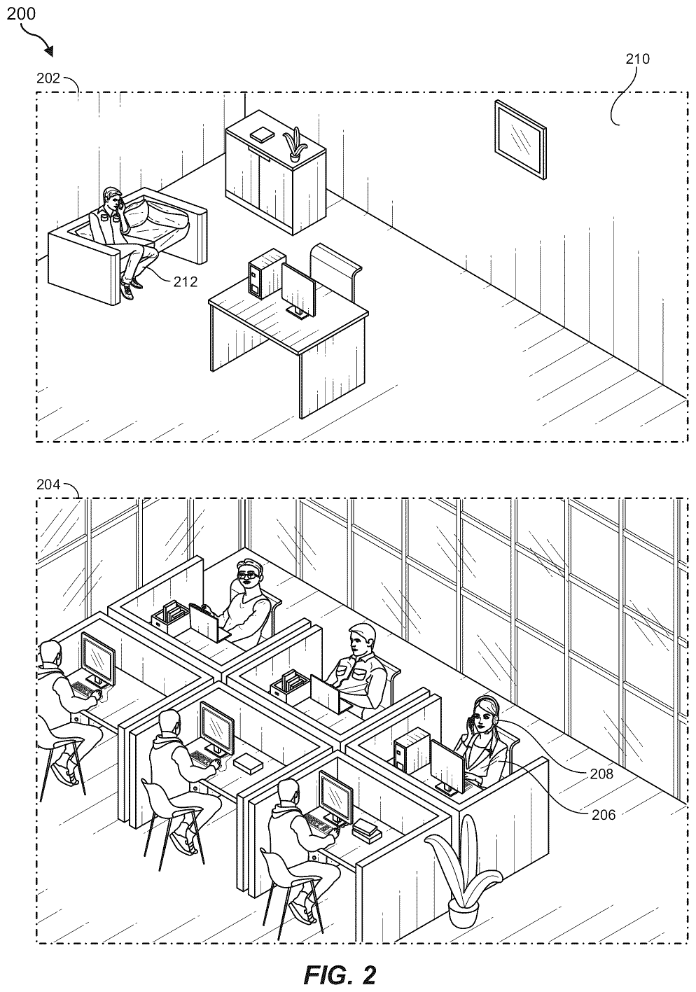

FIG. 2 shows a series 200 of a diagram 202 of a customer or client 212 calling a customer support call center. The client may be located within a cabin 210, and the customer support call center is shown within a diagram 204 including an agent 206 using a headset 208, for example. In various examples, the client may correspond to a customer of a telecommunication provider such as a mobile network operator, a mobile virtual network operator, and/or a content provider such as a television provider or streaming content provider including a direct-broadcast satellite provider. The client may call the agent of the call center to indicate or report any one or more of various types of problems or issues that the client may be experiencing with respect to a product or service provided by the telecommunication provider. Illustrative examples of such problems or issues may include onboarding, pausing, and/or terminating mobile telecommunication services, device malfunctions, interruptions in content streaming or television services, device upgrade inquiries, billing inquiries, etc.

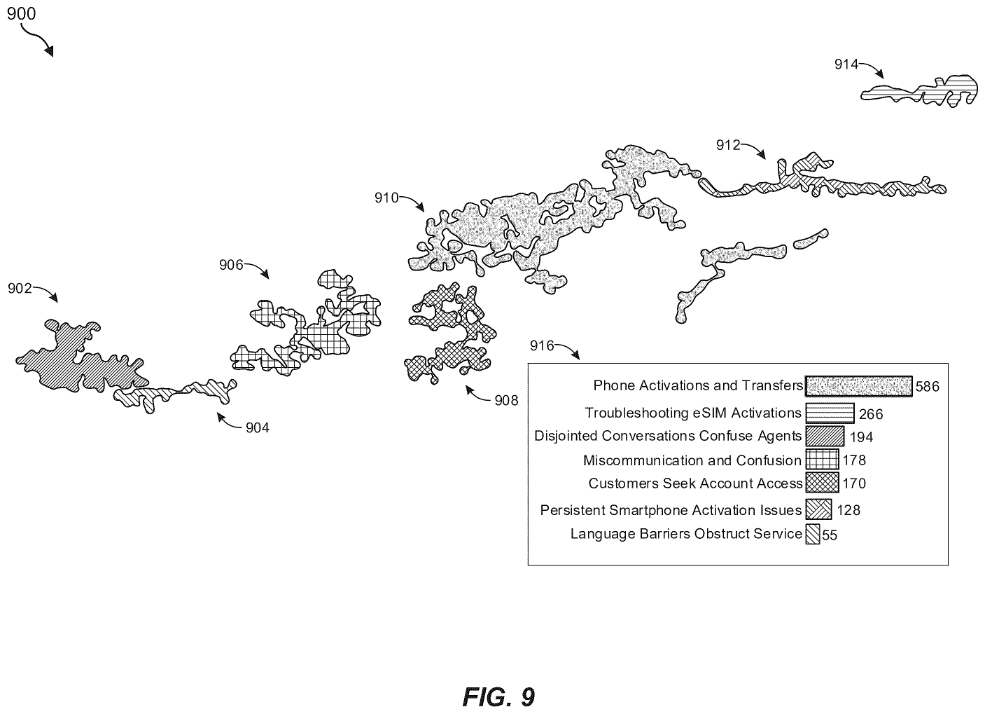

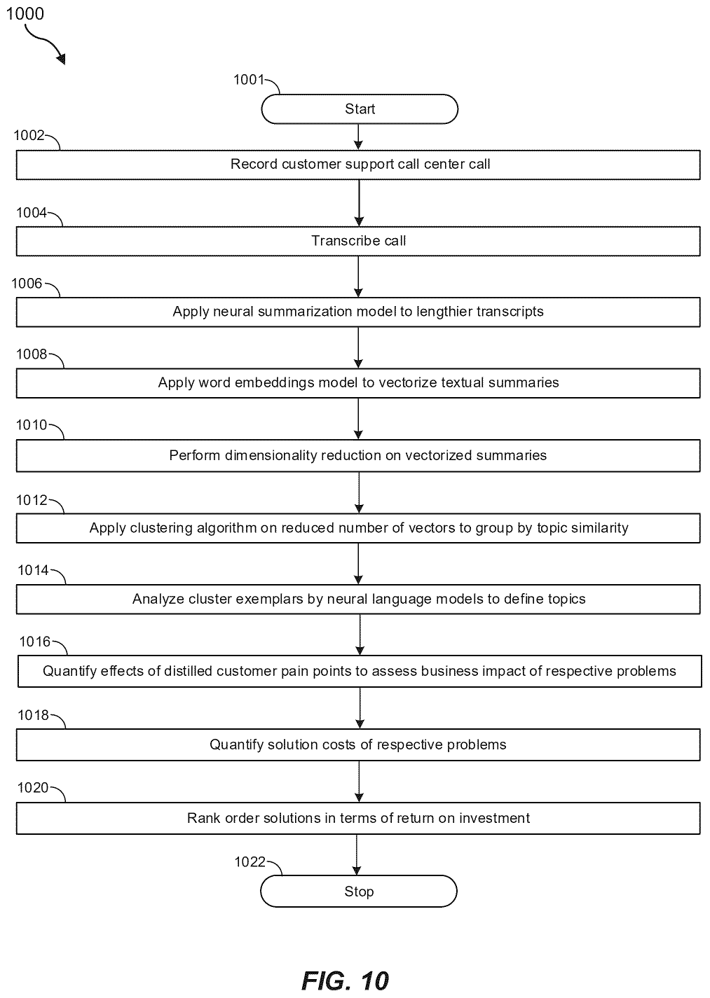

For illustration purposes, diagram 900 within FIG. 9 shows examples of high-level and/or summarized topics corresponding to topics of telephone call recording transcriptions in the context of a telecommunication provider such as a mobile network operator and/or television provider. Accordingly, examples of such topics may include phone activations and transfers, troubleshooting electronic subscriber identity module activations, disjointed conversations confusing agents, general miscommunication and confusion, customers seeking account access, persistence of smartphone activation issues, and/or language barriers obstructing one or more types of services. These topics may have been extracted, identified, and/or labeled onto corresponding clusters of telephone call recording transcriptions in accordance with one or more of the methods described within this disclosure, including method 100 of FIG. 1 and method 1000 of FIG. 10, as discussed in more detail below.

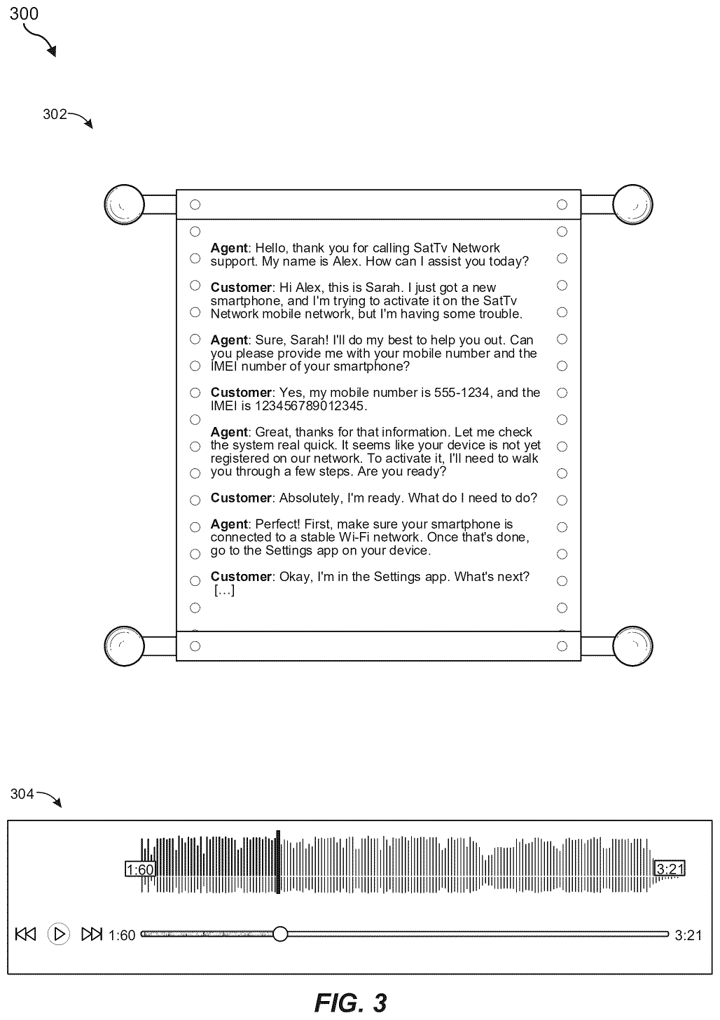

FIG. 3 shows a figurative diagram 300 of a transcript 302 of a call between the customer and an agent at the customer support call center. An audio recording playback indicator 304 helps to illustrate to the reader how an audio recording of the telephone call between the client and the agent that the customer support call center may have been recorded. Additionally, the audio recording of this particular call with the customer support call center may have been automatically or otherwise transcribed, such as manual transcription by a secretary and/or automated transcription through computer processing. Generally speaking, various embodiments of the technologies described within this disclosure may involve transcribing such calls to customer support call centers at scale using automated software or computer systems. As shown within diagram 300, transcript 302 may include a relatively lengthy exchange of sentences, phrases, dialogue excerpts, and/or other statements back and forth between the client and the agent of the customer support call center. The relative length of the transcription of this telephone call can increase the corresponding size of the transcription and/or the size of the file or storage associated with the transcription. These increases in size can furthermore result in increasing computational resources needed or involved with successfully transcribing the audio recording of the telephone call between the client and the customer support call center, especially when a large multitude of different telephone call audio recordings are being transcribed at scale. Accordingly, as further discussed above, it can be desirable, in various embodiments, to find ways to reduce the computational resource burdens associated with transcribing the mass of telephone call recording transcriptions and/or associated with analyzing, categorizing, clustering (i.e., identifying or extracting clusters using a clustering algorithm), running statistics or other analytics, and/or generating actionable business insights or other recommendations based on such analyses at scale. This goal can become especially salient in the context of reaching a qualitative tipping point whereby the speed of processing, analyzing, and/or reporting such business insights and/or actionable items can be performed in real time, consistent with the discussion above and further discussed in more detail below.

As shown, transcript 302 includes the following exchange between the customer and the agent:

Agent: Hello, thank you for calling SatTv Network support. My name is Alex. How can I assist you today?

Customer: Hi Alex, this is Sarah. I just got a new smartphone, and I'm trying to activate it on the SatTv Network mobile network, but I'm having some trouble.

Agent: Sure, Sarah! I'll do my best to help you out. Can you please provide me with your mobile number and the IMEI number of your smartphone?

Customer: Yes, my mobile number is 555-1234, and the IMEI is 123456789012345.

Agent: Great, thanks for that information. Let me check the system real quick. It seems like your device is not yet registered on our network. To activate it, I'll need to walk you through a few steps. Are you ready?

Customer: Absolutely, I'm ready. What do I need to do?

Agent: Perfect! First, make sure your smartphone is connected to a stable Wi-Fi network. Once that's done, go to the Settings app on your device.

Customer: Okay, I'm in the Settings app. What's next?

Agent: Scroll down and tap on “Cellular” or “Mobile Data,” depending on your operating system version. Then, select “Cellular Data Options.”

Customer: Got it. I'm in the Cellular Data Options menu. What should I do now?

Agent: Excellent! Now, tap on “Enable LTE” and choose “Voice & Data.” This ensures that your smartphone can use both voice and data on our network.

Customer: Alright, done. What's the next step?

Agent: Now, go back to the main Settings screen and select “General.” Then, tap on “About” and wait for a few seconds. You should see a pop-up that says “Carrier Settings Update Available.” If prompted, choose to update.

Customer: I see it! I'll go ahead and update the carrier settings now.

Agent: Perfect! After the update is complete, restart your smartphone. Once it's back on, check if you have signal bars and can make a call. If everything's working, your smartphone is now activated on our network.

Customer: Alright, I'll do that right away. Thank you for your help, Alex!

Agent: You're welcome, Sarah! If you encounter any issues or have further questions, don't hesitate to reach out. Enjoy your new smartphone on the SatTv Network mobile network!

Customer: Thanks again, Alex. Have a great day!

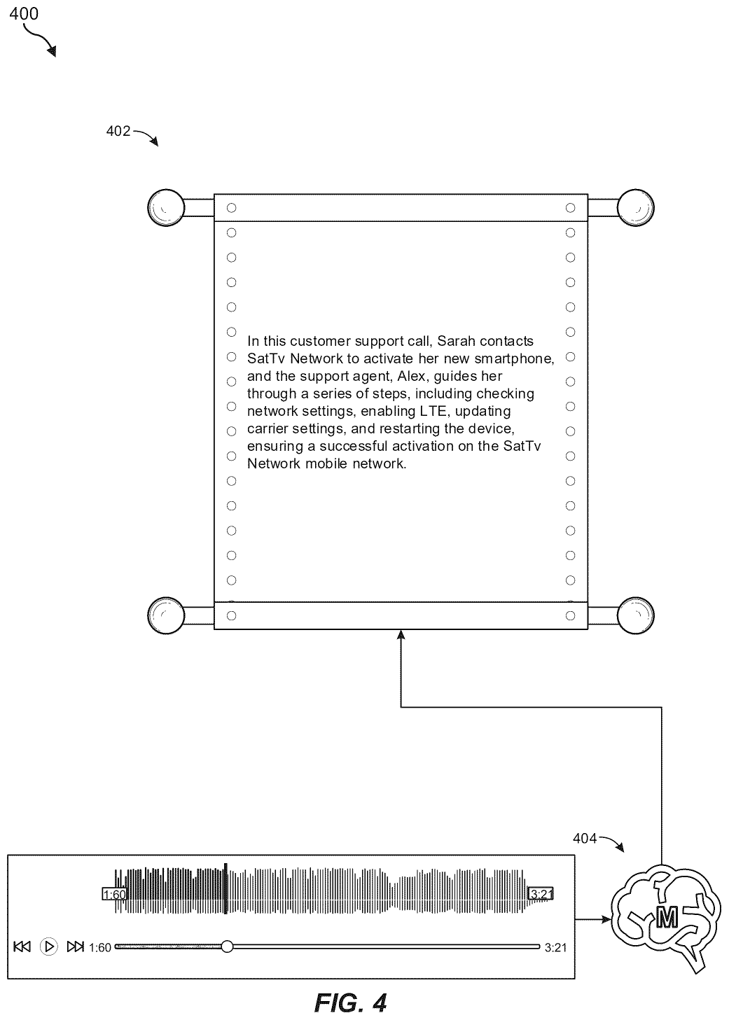

FIG. 4 shows a figurative diagram 400 of a summarization 400 of the transcript of the call between the customer and the agent at the customer support call center where the summarization was generated by a large language model. As shown, summarization 400 states: “In this customer support call, Sarah contacts SatTv Network to activate her new smartphone, and the support agent, Alex, guides her through a series of steps, including checking network settings, enabling LTE, updating carrier settings, and restarting the device, ensuring a successful activation on the SatTv Network mobile network.” Diagram 400 also indicates how the telephone call recording transcription may have been summarized using a machine learning model 404 such as a large language model.

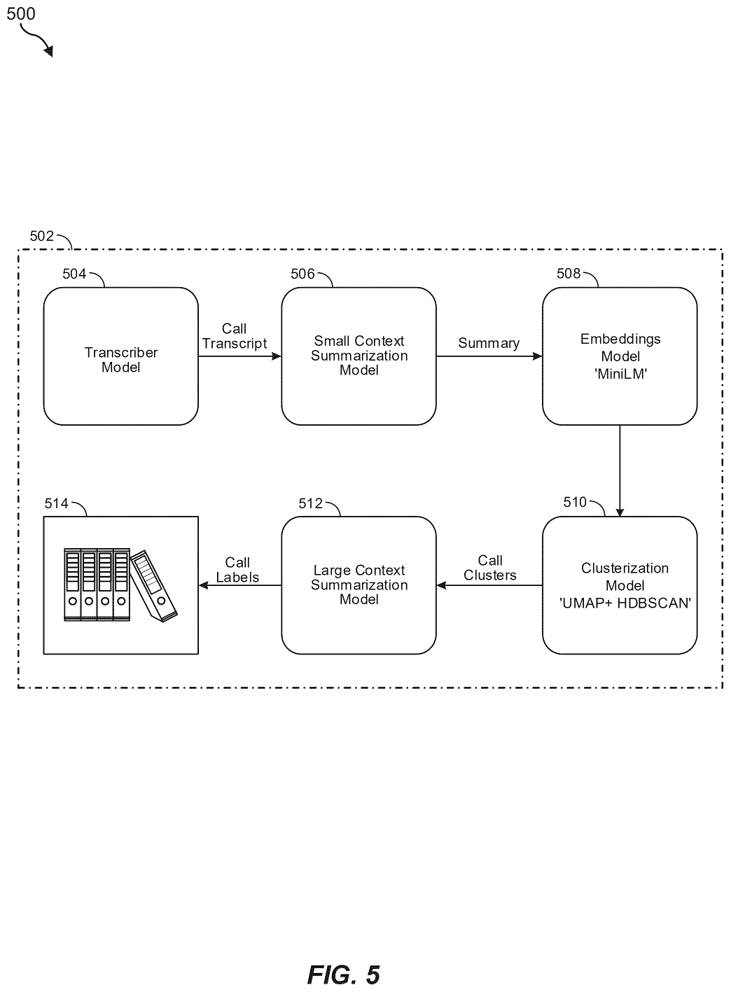

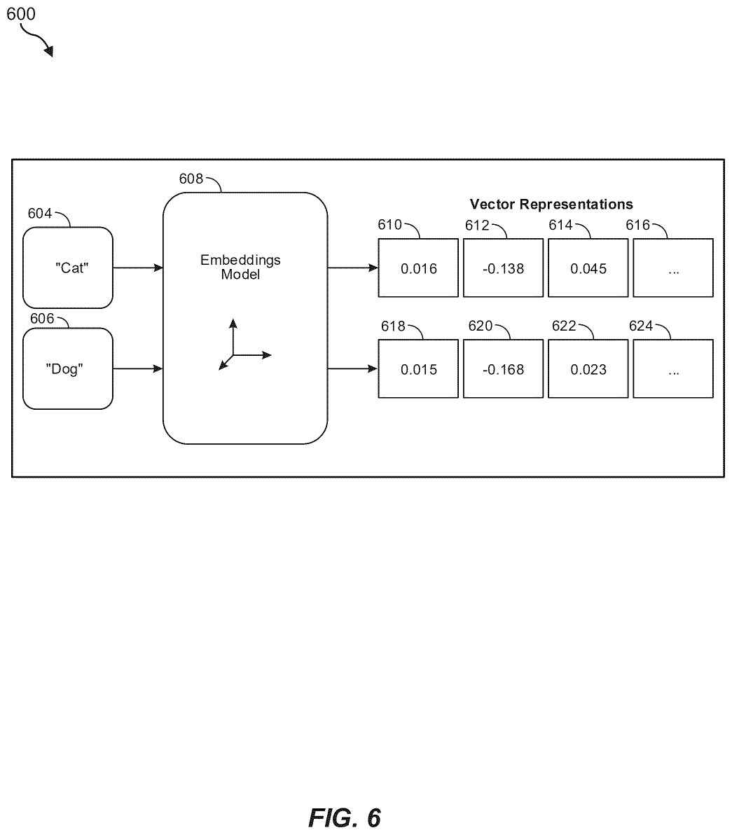

FIG. 5 shows a diagram 502 of at least five models used in sequence as part of call center data mining applications. As shown, these further models may include a transcriber model 504, a small context summarization model 506, an embeddings model 508 such as MiniLm or MiniLM-L6-v2, a clustering model 510, and a large context summarization model 512, which can produce as output a labeled cluster corpus 514 consistent with method 100, method 1000, and/or the various other methods or techniques described within this disclosure. Diagram 500 further indicates that transcriber model 504 can take, as input, the telephone call recording between the client and the agent at the customer support call center and generate a corresponding call transcript. Small context summarization model 506 can take, as input, the telephone call recording transcript and generate a corresponding smaller summarization of the entire transcript, such as by generating a single sentence describing the entire transcript. Embeddings model 508 can take, as input, the summarization of the telephone call recording transcript and generate corresponding word embeddings and/or vectors, as discussed in more detail below. In response, clustering model 510 can accept, as input, the word embeddings and/or vectors and extract or otherwise identify clusters of related or more closely associated vectors from within the original set of vectors generated by embeddings model 508. Large context summarization model 512 can accept, as input, the clusters of respective telephone call recording transcripts and generate a corresponding label for each cluster. The label may optionally provide a single word or shorter phrase as a topic that generally describes the conversations included within that particular cluster. Accordingly, large context summarization model 512 can thereby generate labeled cluster corpus 514. Diagram 502 generally shows a series of models that can correspond to the series of models of method 100 such that any later model in the sequence or chain of operation can provide feedback for improving accuracy of an earlier model. Further details regarding the operation of one or more of these models with respect to generating labeled cluster corpus 514 are described in more detail below with respect to the remaining FIGS. 6-10, for example.

FIG. 6 shows a diagram 600 of a vector representation corresponding to word embeddings for the summarization of the transcript as part of the call center data mining applications. In particular, diagram 600 shows how, for two respective items of text, including a word 604 and a word 606, embeddings model 608 (which can correspond to embeddings model 508) can generate respective vector representations, as shown, including vector cell values 610-616 for word 604 and vector cell values 618-624 for word 606. For illustrative purposes, diagram 600 focuses on a more simplified example using a single word each in the form of word 604 and word 606. Nevertheless, in the larger context of the technologies described within this disclosure relating to processing in real time much lengthier telephone call recording transcripts, at scale, as discussed above, embeddings model 608 can in some embodiments generate word embeddings and/or vector representations instead on entire single sentence summaries or other summaries, as generated by a large language model when processing the corresponding telephone call recording transcripts, resulting in examples such as summarization 402 in diagram 400, as discussed above.

Vector cell values 610-616 and vector cell values 618-624 can specify values, according to word embeddings methodologies, measuring how well the corresponding word or term satisfies, matches, or relates to a measurement along each respective dimension, where each respective dimension corresponds to one of these different cells. Some of the cells might measure dimensions that are understandable or parsable by human intelligence, such as the fact that both cats and dogs are animals or the fact that both cats and dogs have four legs. One or more of the cells within this illustrative example in the figure may correspond to such measurements that are understandable by human intelligence. Additionally, or alternatively, in other examples one or more of the cells may be generated through machine learning methodologies, resulting thereby in a dimension and/or measurement that is not readily understandable or parsable by human intelligence and, instead, measures a more complicated, nuanced, abstract, and/or inconspicuous attribute with respect to the terms under analysis.

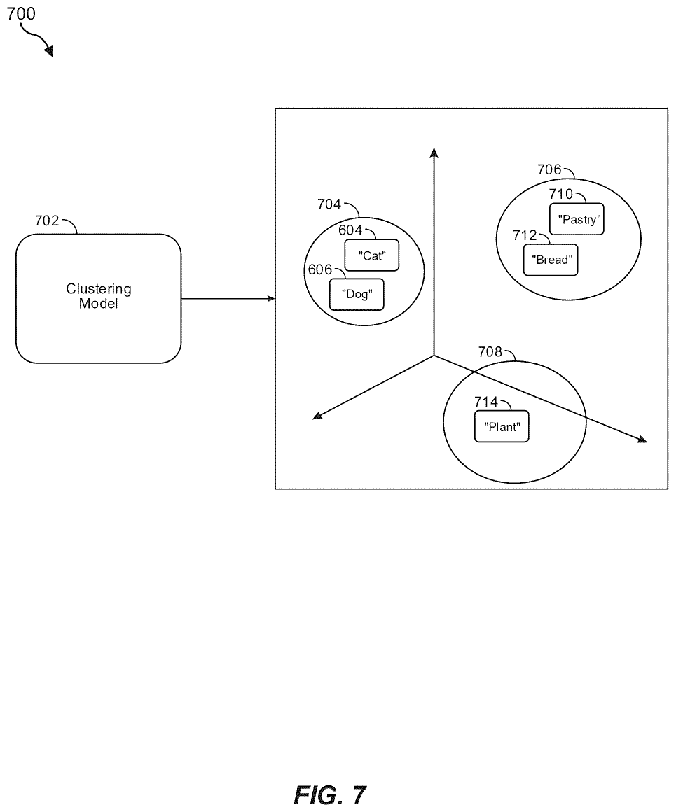

FIG. 7 shows a figurative diagram 700 indicating how a clustering model can extract clusters from a multiplicity of topics or text strings. In particular, diagram 700 shows how clustering model 702 can generate a cluster 704, a cluster 706, and a cluster 708 based on an analysis of corresponding word embeddings and/or vectors (see diagram 600) for word 604, word 606, a word 710, a word 712, and a word 714. As discussed above, one or more of the cells within these vectors or word embeddings may describe or measure an attribute that cats and dogs share together, such as the fact that both cats and dogs are animals or the fact that both cats and dogs have four legs. Accordingly, the corresponding values of one or more of these cells for these two respective terms, word 604 and word 606, may be more comparatively or proportionally similar for those respective measurements. Based on the similarity, clustering model 702 may effectively group word 604 and word 606 together within the same cluster 704, as shown. In contrast, word 710, word 712, and word 714 may not satisfy one or more of these measurements, because these words refer to items that are not animals and/or items that do not have four legs. Nevertheless, clustering model 702 may group word 710 and word 712 together due to the fact that both of these words refer to items of food and in particular refer to items of baked goods. In contrast, word 714 does not necessarily refer to food and in particular does not refer to baked goods. Accordingly, clustering model 702 can detect the greater level of distance between word 714 and the cells or measurements on which word 710 and word 712 show similarity, thereby enabling clustering model 702 to generate a new and distinct cluster for word 714 in the form of cluster 708, as shown. As discussed above, the example of diagram 700 may be simplified to show clusters extracted from a multiplicity of different words or phrases, whereas method 100, method 1000, and/or one or more of the other techniques or methodologies described within this disclosure may extract clusters from a multiplicity of summarizations of telephone call recording transcripts in the context of customer support call centers for telecommunication providers.

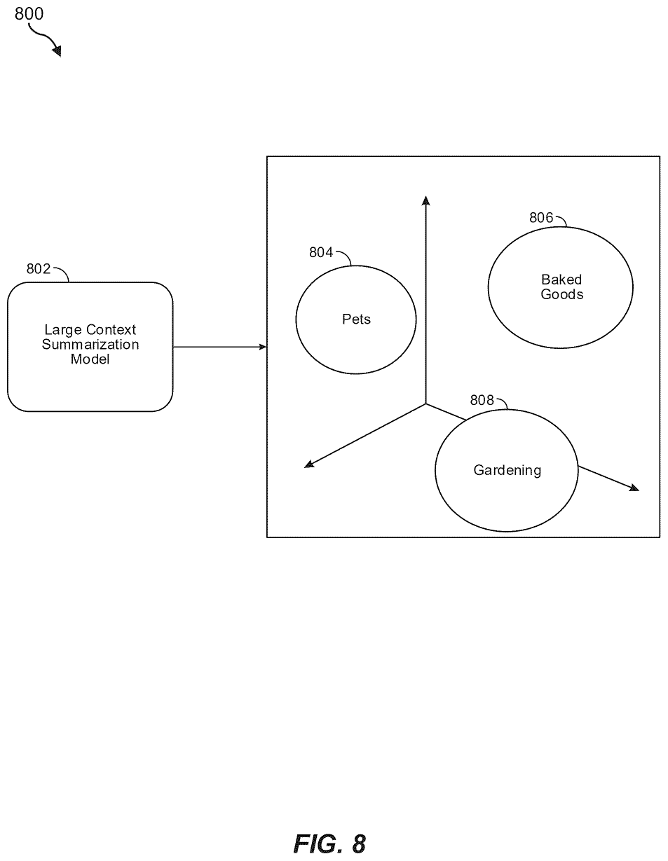

FIG. 8 shows a diagram 800 illustrating how a large context summarization model can summarize, label, or assign a topic to each cluster from the extracted clusters. In particular, large context summarization model 802 can summarize cluster 704 as pets 804. Similarly, large context summarization model 802 can summarize cluster 708 as gardening 808, as shown. Lastly, large context summarization model 802 can summarize cluster 706 as baked goods 806. Generally speaking, large context summarization model 802 can perform a meta-summarization feature whereby large context summarization model 802 takes in clusters of summaries of telephone call recording transcripts, as discussed at length above, and provides a second layer of summarization by providing a topic, label, phrase, or single sentence summary of the entire cluster, for each respective cluster, where each item in the cluster itself constitutes a summarization, thereby providing two layers of summarization.

FIG. 9 shows a diagram 900 illustrating how the large context summarization model can be leveraged to summarize clusters of topics corresponding to transcripts of calls between various customers and the customer support call center. In other words, in contrast to the simplified examples of FIGS. 6-8, diagram 900 shows that the final topic, label, phrase, single sentence, or other summarization of clusters in the context of method 100 or method 1000 may describe topics that commonly arise within telephone call recording transcripts that are directed from customers to a customer support call center for a telecommunication provider, as discussed above. Diagram 900 illustrates these different clusters in the forms of a cluster 902, a cluster 904, a cluster 906, a cluster 908, a cluster 910, a cluster 912, and a cluster 914. A legend 916 uses different types of shading or hatching to indicate how different ones of these clusters within diagram 900 are given respective labels that are listed within this legend. By way of illustrative example, cluster 910 may have the label “phone activations and transfers.” Similarly, cluster 914 may have the label “troubleshooting electronic subscriber identification module activations.” Not only does legend 916 indicate the label for each respective cluster identified or extracted using the clustering algorithm discussed above, legend 916 also furthermore provides a count of the number of telephone call recording transcripts that belong to that particular and respective cluster. Accordingly, cluster 910 has a count of 586 different telephone call recording transcripts belonging to it. In contrast, cluster 914 has a count of 266 different telephone call recording transcripts belonging to it, as shown. In view of the above, diagram 900 also helps to further illustrate how one or more of the methods or techniques described within this disclosure may not only label, categorize, associate, group together, and/or cluster telephone call recording transcripts, but these methods may also furthermore rank them in order of importance, where one factor indicating importance is the number or proportion of calls directed to that particular topic (i.e., because more important or more urgent issues result in more customer complaints).

FIG. 10 shows a flow diagram for a method 1000 in another embodiment corresponding to a detailed implementation of method 100. At step 1001, method 1000 may start or begin. At step 1002, method 1000 may include recording a customer support call center call. At step 1004, method 1000 may include transcribing the call. Step 1004 can correspond to generating the original corpus of support call transcriptions by transcribing the support calls received at the telecommunication provider. The transcription process can involve removing personally identifiable information, updating punctuation, labeling a respective transcription with at least one sentiment label, and/or performing proofreading.

At step 1006, method 1000 may include applying a neural summarization model or large language model to lengthier transcripts (i.e., lengthier than the summarizations generated by the summarization model). In some examples, the large language model has been fine-tuned on a domain relating to the support calls received at the telecommunication provider. For example, after the identification or extraction of one or more clusters (see diagram 900 in FIG. 9), the telecommunication provider can go back and fine-tune the large language model and/or a corresponding machine learning model, which can be based on the large language model, using a data set that is specific to the particular cluster. For example, one or more machine learning models may be fine-tuned using the corpus of telephone call recording transcripts and/or summaries that strictly belong to that particular cluster, such that the machine learning model becomes more expert or more specific to the topic of that particular cluster. Illustrative examples of such expert machine learning models or large language models may correspond to the examples of clusters shown within diagram 900, including “phone activations and transfers,” as well as “troubleshooting electronic subscriber identity module activations,” as shown. Additionally, or alternatively, rather than fine-tuning one or more machine learning models on the corpus of telephone call recording transcripts and/or summarizations, the machine learning model may be fine-tuned on a separate and distinct corpus of data that is nevertheless specific to the targeted topic of the cluster, as identified according to method 100 and/or method 1000. For example, the telecommunication provider can provide a separate and more robust corpus of data relating to “phone activations and transfers” and thereby fine-tune one or more machine learning models on that particular topic using that separate and more robust corpus of data. Subsequently, the machine learning model, large language model, and/or other artificial intelligence assistant may facilitate the providing of customer support to one or more clients, customers, or callers newly seeking customer support from the telecommunication provider. In some examples, the artificial intelligence assistant may include a helper large language model. Accordingly, in these examples, method 100 and/or method 1000 may further include training the helper large language model on a corpus of training data that is tailored to address a specific client support topic for a specific cluster from the ranked ordering of client support topics for clusters within the summary corpus of large language model generated summaries of support call transcriptions.

For example, a human agent at the customer support call center of the telecommunication provider might beneficially interact and/or coordinate with such an artificial intelligence assistant when handling or responding to a particular client or customer on a call that is labeled, summarized, and/or otherwise directed to the topic of the corresponding cluster to which the artificial intelligence assistant was fine-tuned. Accordingly, a new incoming call directed to “phone activations and transfers” could benefit from the client and/or the human agent who is assisting the client interacting with an artificial intelligence assistant or other large language model that was fine-tuned on the particular topic of “phone activations and transfers,” consistent with the discussion above.

Additionally, or alternatively, in some examples the large language model is specific to the domain relating to the support calls received at the telecommunication provider. For example, the large language model may have been trained on a corpus of data that is specific to the telecommunication provider or that was generated by the telecommunication provider. In other words, in some examples, in addition to processing and/or summarizing a corpus of data or telephone call recording transcripts from the telecommunication provider, the large language model may itself have been trained using such a corpus of data.

In various examples, the large language model has been optimized for generating summaries. Accordingly, the large language model may be distinguished from other large language models that are more general purpose and/or that generate lengthier output as distinct from shorter summaries, as discussed above. Additionally, or alternatively, in further examples prompting the large language model is performed using a prompt format for generating summaries that has been selected as superior from among multiple tested prompt formats for generating summaries. For example, the telecommunication provider and/or engineering team within the telecommunication provider may have tested multiple different prompt formats and ascertained, through testing, that a specific prompt format generates superior returns. Accordingly, this particular prompt format, which may have been selected as superior in a tournament competition with other prompt formats, may be utilized by the telecommunication provider in the context of performing method 100 and/or method 1000.

At step 1008, method 1000 may include applying a word embeddings model to vectorized textual summaries. For example, a sentence embeddings model can vectorize the summary corpus of large language model generated summaries of support call transcriptions such that an original vector corpus is produced with a respective vector for each large language model generated summary in the summary corpus of large language model generated summaries. In some examples, the sentence embeddings model comprises MiniLM or all-MiniLM-L6-v2.

At step 1010, method 1000 may include performing dimensionality reduction on the vectorized textual summaries. According to dimensionality reduction, not all of the cells that contribute to the length of each respective vector may be equally valuable or informative, whereas some of these may be redundant and/or uninformative. Accordingly, one or more dimensionality reduction techniques can be performed to reduce the number of dimensions and/or cells of respective vectors while nevertheless preserving a threshold level of information encoded within the cells. In some examples, performing dimensionality reduction is performed according to uniform manifold approximation and projection, which is a methodology understood by those having skill in the art.

At step 1012, method 1000 may include applying a clustering algorithm on the reduced number of vectors to group these by topic similarity. In these examples, method 100 and/or method 1000 may further include generating or extracting the clusters within the summary corpus of large language model generated summaries of support call transcriptions at least in part by extracting the clusters from the reduced vector corpus. In some more specific examples, generating the clusters is performed according to hierarchical density-based spatial clustering of applications with noise, which is a particular methodology understood by those having skill in the art.

At step 1014, method 1000 may include analyzing cluster exemplars by a neural language model to find corresponding topics. In other words, in the context of step 1014, method 100 and/or method 1000 may further include labeling the clusters with the client support topics by prompting, for each respective cluster, a same or different large language model to generate a respective label based on reading a sample of the large language model generated summaries of support call transcriptions within the respective cluster. In some examples, the sample may include a number of summaries that maximizes an equation evaluating the trade-off between higher-level accuracy due to a larger number of summaries in the sample and a lower level of accuracy due to a lower number of summaries in the sample. In some examples, the sample is randomly selected. In some examples, the sample includes representative exemplars of summaries such that one or more additional summaries may be excluded from the sample due to the fact that the summaries essentially repeat or indicate the same topic as the representative exemplars.

In various examples, one or more portions, steps, and/or acts of method 100 and/or method 1000 may be performed through a graphics processing unit. For example, dimensionality reduction can be performed through a graphics processing unit and/or extracting the clusters from the reduced vector corpus can be performed through the graphics processing unit. Additionally, or alternatively, any suitable one or more of the remaining steps or acts within method 100 and/or method 1000 may be performed using the graphics processing unit to achieve accelerated processing or hardware acceleration.

At step 1016, method 1000 may include quantifying effects of distilled customer pain points to assess business impact of respective problems. At step 1018, method 1000 may include quantifying solution costs of respective problems. At step 1020, method 1000 may include rank ordering the solutions in terms of return on investment.

In the context of steps 1016-1020, method 100 and/or method 1000 may further include extracting the ranked ordering of client support topics for clusters within the summary corpus of large language model generated summaries of support call transcriptions at least in part by quantifying a first cost for a first cluster in terms of call center load or effect on client lifetime value. For example, one or more of these methods may include calculating, determining, or estimating that a particular client has a client lifetime value of $50,000 to the telecommunication provider. Accordingly, the method may further include estimating that the problem, issue, or topic for the first cluster results in a cost of $10,000 from the client lifetime value, resulting in the remaining total of $40,000. In some examples, the client lifetime value and/or total remaining client lifetime value may be multiplied by the number of affected clients, generating an overall cost or return to the telecommunication provider.

In the above examples, the method can further include quantifying a second cost for the first cluster of resolving the respective topic for the first cluster. For example, the telecommunication provider may calculate, determine, or estimate that resolving the issue that reduces the client lifetime value by $10,000 would itself cost $5000. Accordingly, the net profit from resolving this issue would be $5000 for a single client (i.e., in a scenario where the single $5000 solution resolves the problem for all affected clients). In this manner, the telecommunication provider can arrive at a calculation, determination, or estimate of the total return on investment for resolving the issue, which would correspond to, or be proportionate to, the total profit per client multiplied by the number of clients and divided by the cost of resolving the issue (i.e., $5000), for example. Additionally, or alternatively, the cost of resolving the issue may be subtracted from the total profit per client multiplied by the number of clients.

In further embodiments and/or examples, extracting the ranked ordering of client support topics for clusters within the summary corpus of large language model generated summaries of support call transcriptions includes quantifying a return on investment for the first cluster by increasing the return on investment in proportion to the first cost (i.e., the return on investment increases in proportion to the cost to client lifetime value, which is eliminated by solving the issue and increasing the return on investment) or reducing the return on investment in proportion to the second cost (i.e., the cost of resolving the issue, such that more expensive solutions are associated with proportionally lower return on investments, all else equal, due to the greater expense). In these examples and related examples, extracting the ranked ordering of client support topics for clusters within the summary corpus of large language model generated summaries of support call transcriptions can include ranking a first respective cluster higher based on a first return on investment for the first cluster being higher than a second return on investment for a second cluster in the clusters. For example, if resolving a first topic for a first cluster is estimated to provide a $60,000 return on investment and resolving a second topic for a second cluster is estimated to provide a $50,000 return on investment, then resolving the first topic may be prioritized by the telecommunication provider. Lastly, at step 1022, method 1000 may stop or conclude.

In some examples, method 100 and/or method 1000 may include performing domain adaptation on the large language model. In other words, and in one or more various different scenarios, the large language model may have been trained on a corpus of data at a particular time whereas the large language model may be deployed later in a different context that has some difference or differences from the original corpus of data. In some examples, the large language model may have been trained in a corpus of data from several years ago in the past, in which case various aspects of the telecommunication provider, its services, its technologies, and/or its corresponding vocabulary may have changed with a natural drift of technological improvement. Additionally, or alternatively, the large language model may have been initially trained on a corpus of data in one context, such as the context of a mobile network operator, but the telecommunication provider may later seek to deploy the large language model within a related but distinct context, such as the context of a television provider. In various examples, the telecommunication provider may operate in a variety of different contexts and circumstances, thereby providing products and/or services within multiple and distinct economic or technological niches. In such examples, the original training of the large language model may become increasingly outdated and/or increasingly less relevant due to the changing context or circumstances since the time of training or the later time of deployment in a new context. In such scenarios, the telecommunication provider can perform one or more procedures of domain adaptation on the large language model to help update the large language model and/or to make the large language model more fine-tuned, specific, and/or accurate within a new and distinct context, consistent with the discussion above. Moreover, domain adaptation can be performed to create a cluster-specific or topic-specific artificial intelligence assistant, as further discussed above.

Lastly, in various examples, extracting from the summary corpus of large language model generated summaries of support call transcriptions the ranked ordering of client support topics for clusters within the summary corpus of large language model generated summaries of support call transcriptions is performed in real time. Performing the extracted procedure in real time can result in the ranked ordering being extracted in a first amount of time that is less or equal to a second amount of time defining a span of time during which the support calls were received at the telecommunication provider. For example, if the support calls processed according to method 100 were received within the month of March, then method 100 can be performed in real-time by completing the processing of method 100 within an amount of time equal, or less than, the size of the month of March. In this manner, a processing pipeline could keep up with the pace of incoming telephone call recording transcripts without becoming overburdened or failing to keep pace with the incoming telephone call recording transcripts, as further discussed above.

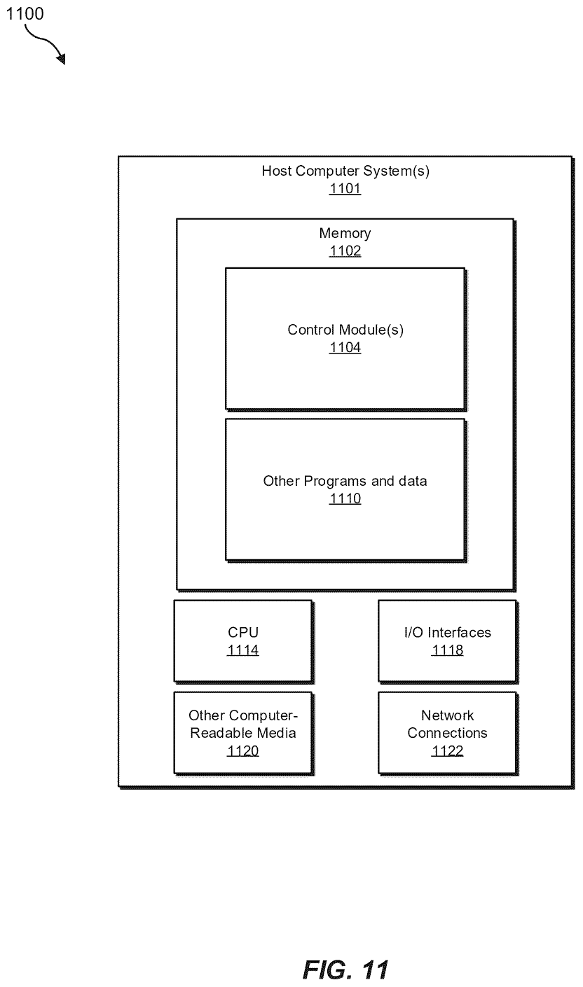

FIG. 11 shows a system diagram that describes an example implementation of a computing system(s) for implementing embodiments described herein. The functionality described herein can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility. However, FIG. 11 illustrates an example of underlying hardware on which such software and functionality may be hosted and/or implemented.

In particular, shown is example host computer system(s) 1101. For example, such computer system(s) 1101 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 1101 may include memory 1102, one or more central processing units (CPUs) 1114, I/O interfaces 1118, other computer-readable media 1120, and network connections 1122.

Memory 1102 may include one or more various types of non-volatile and/or volatile storage technologies. Examples of memory 1102 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 1102 may be utilized to store information, including computer-readable instructions that are utilized by CPU 1114 to perform actions, including those of embodiments described herein.

Memory 1102 may have stored thereon control module(s) 1104. The control module(s) 1104 may be configured to implement and/or perform some or all of the functions of the systems or components described herein. Memory 1102 may also store other programs and data 1110, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 1122 are configured to communicate with other computing devices to facilitate the functionality described herein. In various embodiments, the network connections 1122 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1118 may include a video interface, other data input or output interfaces, or the like. Other computer-readable media 1120 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
transforming an original corpus of support call transcriptions for support calls received at a telecommunication provider at least in part by prompting a large language model from a series of models to summarize each support call transcript in the original corpus of support call transcripts for the support calls received at the telecommunication provider to output a summary corpus of large language model generated summaries of support call transcriptions;
vectorizing, by a sentence embeddings model, the summary corpus of large language model generated summaries of support call transcriptions such that an original vector corpus is produced with a respective vector for each large language model generated summary in the summary corpus of large language model generated summaries;
extracting, by referencing the original vector corpus, from the summary corpus of large language model generated summaries of support call transcriptions a ranked ordering of client support topics for clusters within the summary corpus of large language model generated summaries of support call transcriptions;
resolving, by the telecommunication provider, the client support topics in an actual order that is determined at least in part based on the ranked ordering of client support topics for clusters within the summary corpus of large language model generated summaries of support call transcriptions; and
improving accuracy of at least one earlier model in the series of models based on feedback received from a later model in the series of models.

2. The method of claim 1, further comprising generating the original corpus of support call transcriptions by transcribing the support calls received at the telecommunication provider.

3. The method of claim 2, wherein transcribing comprises at least one of:
removing personally identifiable information;
updating punctuation;
labelling with at least one sentiment label; or
performing proofreading.

4. The method of claim 1, wherein:
the large language model has been fine-tuned on a domain relating to the support calls received at the telecommunication provider;
the large language model is specific to the domain relating to the support calls received at the telecommunication provider;
the large language model has been optimized for generating summaries; or
prompting the large language model is performed using a prompt format for generating summaries that has been selected as superior from among multiple tested prompt formats for generating summaries.

5. The method of claim 1, further comprising performing domain adaptation on the large language model.

6. The method of claim 1, further comprising labeling the clusters with the client support topics by prompting, for each respective cluster, a same or different large language model to generate a respective label based on reading a sample of the large language model generated summaries of support call transcriptions within the respective cluster.

7. The method of claim 1, further comprising training a helper large language model on a corpus of training data that is tailored to address a specific client support topic for a specific cluster from the ranked ordering of client support topics for clusters within the summary corpus of large language model generated summaries of support call transcriptions.

8. The method of claim 1, wherein extracting the ranked ordering of client support topics for clusters within the summary corpus of large language model generated summaries of support call transcriptions comprises quantifying a first cost for a first cluster in terms of call center load or effect on client lifetime value.

9. The method of claim 8, wherein extracting the ranked ordering of client support topics for clusters within the summary corpus of large language model generated summaries of support call transcriptions comprises quantifying a second cost for the first cluster of resolving the respective topic for the first cluster.

10. The method of claim 9, wherein extracting the ranked ordering of client support topics for clusters within the summary corpus of large language model generated summaries of support call transcriptions comprises quantifying a return on investment for the first cluster by increasing the return on investment in proportion to the first cost or reducing the return on investment in proportion to the second cost.

11. The method of claim 1, wherein extracting the ranked ordering of client support topics for clusters within the summary corpus of large language model generated summaries of support call transcriptions comprises ranking a first respective cluster higher based on a first return on investment for the first cluster being higher than a second return on investment for a second cluster in the clusters.

12. The method of claim 1, wherein the client support topics comprise at least two of:
phone activations or transfers;
troubleshooting electronic subscriber identity module activations;
customers seeking account access;
general confusion; or
language barriers.

13. The method of claim 1, wherein the sentence embeddings model comprises all-MiniLM-L6-v2.

14. The method of claim 12, further comprising performing dimensionality reduction on the original vector corpus to generate a reduced vector corpus.

15. The method of claim 14, wherein performing dimensionality reduction is performed according to uniform manifold approximation and projection.

16. The method of claim 14, further comprising generating the clusters within the summary corpus of large language model generated summaries of support call transcriptions at least in part by extracting the clusters from the reduced vector corpus.

17. The method of claim 16, wherein:
performing dimensionality reduction is performed through a graphics processing unit; or
extracting the clusters from the reduced vector corpus is performed through the graphics processing unit.

18. The method of claim 16, wherein generating the clusters is performed according to hierarchical density-based spatial clustering of applications with noise.

19. A system comprising:
at least one physical computing processor of a computing device; and
a non-transitory computer-readable medium that has instructions stored thereon that, when executed by the at least one physical computing processor, cause the computing device to perform operations comprising:
transforming an original corpus of support call transcriptions for support calls received at a telecommunication provider at least in part by prompting a large language model from a series of models to summarize each support call transcript in the original corpus of support call transcripts for the support calls received at the telecommunication provider to output a summary corpus of large language model generated summaries of support call transcriptions;
vectorizing, by a sentence embeddings model, the summary corpus of large language model generated summaries of support call transcriptions such that an original vector corpus is produced with a respective vector for each large language model generated summary in the summary corpus of large language model generated summaries;
extracting, by referencing the original vector corpus, from the summary corpus of large language model generated summaries of support call transcriptions a ranked ordering of client support topics for clusters within the summary corpus of large language model generated summaries of support call transcriptions;
resolving, by the telecommunication provider, the client support topics in an actual order that is determined at least in part based on the ranked ordering of client support topics for clusters within the summary corpus of large language model generated summaries of support call transcriptions; and
improving accuracy of at least one earlier model in the series of models based on feedback received from a later model in the series of models.

20. A non-transitory computer-readable medium that has instructions stored thereon that, when executed by at least one physical computing processor, cause a computing device to perform operations comprising:
transforming an original corpus of support call transcriptions for support calls received at a telecommunication provider at least in part by prompting a large language model from a series of models to summarize each support call transcript in the original corpus of support call transcripts for the support calls received at the telecommunication provider to output a summary corpus of large language model generated summaries of support call transcriptions;
vectorizing, by a sentence embeddings model, the summary corpus of large language model generated summaries of support call transcriptions such that an original vector corpus is produced with a respective vector for each large language model generated summary in the summary corpus of large language model generated summaries;
extracting, by referencing the original vector corpus, from the summary corpus of large language model generated summaries of support call transcriptions a ranked ordering of client support topics for clusters within the summary corpus of large language model generated summaries of support call transcriptions;
resolving, by the telecommunication provider, the client support topics in an actual order that is determined at least in part based on the ranked ordering of client support topics for clusters within the summary corpus of large language model generated summaries of support call transcriptions; and
improving accuracy of at least one earlier model in the series of models based on feedback received from a later model in the series of models.
